(19) United States
(12) Patent Application Publication
(10) Pub. No.: US 2007/0022232 A1
(43) Pub. Date: Jan. 25, 2007

(54) CELLULAR TELEPHONE WITH INTEGRATED USB PORT ENGAGEMENT DEVICE THAT PROVIDES ACCESS TO MULTIMEDIA CARD AS A SOLID-STATE DEVICE

(75) Inventors: JAYESH R. BHAKTA, CERRITOS, CA (US); VALERIE C. CHAN, NEWPORT BEACH, CA (US); SCOTT H. MILTON, IRVINE, CA (US)

Correspondence Address: JERRY TURNER SEWELL, P.O. BOX 10999, NEWPORT BEACH, CA, 92658-5015, US

(73) Assignee: JVSD TECHNOLOGIES, LAGUNA NIGUEL, CA (US)

(21) Appl. No.: 11/161,448

(22) Filed: Aug. 3, 2005

Related U.S. Application Data
(60) Provisional application No. 60/595,619, filed on Jul. 20, 2005.

(51) Int. Cl. G06F 13/38; G06F 13/12

(52) U.S. Cl. 710/62

(57) ABSTRACT

A cellular telephone includes a multimedia card (MMC) having storage capacity for computer data files. An engagement device for a data transfer interface (e.g., a universal serial bus (USB) interface) is permanently mounted to the housing of the cellular telephone. The engagement device is movable from a nonobstructing home position to an extended position to allow a user to plug the cellular telephone directly into a computer or other data processing system without requiring addition cables or connectors. The MMC is configured and controlled by a microcontroller or other control device to emulate a solid-state drive such that a user has the full capabilities of a solid-state drive and a cellular telephone in a single convenient housing.

### RELATED APPLICATIONS

The present application claims the benefit of priority under 35 U.S.C. § 119(e) of U.S. Provisional Application No. 60/595,619, filed on Jul. 20, 2005.

### BACKGROUND OF THE INVENTION

1. Field of the Invention

This application relates to cellular telephones and computer systems, and more particularly relates to data storage systems for cellular telephones.

2. Description of the Related Art

Cellular telephones have become commodity items such that most business persons, students, and a substantial portion of the rest of the population of the United States and other countries carry cellular telephones in order to be able to communicate telephonically at almost any time and in almost any place.

Most business persons, students, and a substantial portion of the general population of the United States also have personal computer systems for document generation, financial calculations, calendaring and electronic mail communications, and the like. Many persons have multiple personal computers in different locations. For example, a business person may have a desktop computer at the office, may have another desktop computer at home, and may have a notebook computer for traveling and for presenting information during business meetings. Similarly, a student may have a desktop computer for primary use at home or in a dormitory room and may have a notebook computer for use in other locations. It is often necessary to transfer data between a person's different computers. Also, it is frequently necessary to transfer data to a computer of another person or business (e.g., to allow collaboration on a project). Many systems are used to transfer data between computers. For example, the computers may be interconnected via a network or other communication channel; however, in a substantial portion of the cases, the data files from one computer are first transferred to a data storage medium, such as, for example, to a floppy disk, a Zip disk, a compact disk, or a DVD. The data files are then transferred from the data storage medium to a second computer.

A particular type of medium that is becoming more popular as the prices decrease and the capacities increase is a non-volatile semiconductor memory device. The memory device plugs into the computer via a port to enable data transfer and is removable from the port for transportation. The memory device can be plugged into a port of another computer so that the data files in the memory device are accessible by the second computer. Generally, such memory devices are quite small and are relatively rugged in comparison to conventional magnetic media or optical media. Such devices are often referred to as flash drives, memory keys, USB drives, jump drives, solid-state disk drives, or the like. In many cases, a typical removable semiconductor memory device plugs into a Universal Serial Bus (USB) port of the computer and is automatically recognized by the operating system of the computer as another disk drive. For example, a Windows-based operating system assigns a drive letter to the removable device when the device is plugged into a USB port and the device driver senses the presence of the device. Hence, the user of the computer is able to transfer data to and retrieve data from the removable device by selecting the assigned drive letter as the destination or the source for the data. In the following description, such removable semiconductor memory devices are referred to as USB flash drives or solid-state drives.

As indicated above, the solid-state drives are small and highly portable. These characteristics are beneficial in comparison to the earlier removable media; however, the small sizes of the solid-state drives are also detrimental. A small memory device is easy to lose and is often difficult to locate in a cluttered briefcase or computer case. The device can be overlooked when packing for a business trip or when returning from a business trip. Thus, the data files stored in the device may not be available when needed. Furthermore, if the device is lost, important data stored in the device may be lost. Although some solid-state drives can be attached to a key chain or the like, many persons do not want to add items to key chains or may not want to carry additional items to meetings or on business trips.

### SUMMARY OF THE INVENTION

In view of the foregoing, a need exists for a USB flash drive device that retains the portability of conventional USB flash drive devices but that is also convenient to carry and easy to locate and control. The present invention is responsive to this need by incorporating a USB flash drive into a cellular telephone. In accordance with aspects of the present invention, a cellular telephone includes a memory device, at least a portion of which is configurable as a data storage device for a computer system. The memory device is coupled to a USB interface port such that data are transferred to and from the memory device via the USB interface. The USB interface port is electronically coupled to a USB port engagement device, which is mechanically configured as a permanently attached extension of the housing of the cellular telephone. The engagement device is moveable from a home position to an operational position wherein the engagement device can be plugged directly into a mating USB port of a computer without using any USB cables or other interconnection components. When the USB engagement device of the cellular telephone is engaged with the USB port of the computer, the memory device in the cellular telephone is recognizable as an accessible drive device by the computer (e.g., the memory device is identified as a drive that is accessible in the same manner as conventional drives). In advantageous embodiments, the battery of the cellular telephone is trickle-charged with power provided by the computer while the cellular telephone and the computer are interconnected. The engagement device is movable to a home position when the cellular telephone is disengaged from the computer so that the engagement device does not interfere with the operation of the cellular telephone as a communication device.

An aspect in accordance with embodiments of the present invention is a cellular telephone that comprises a housing. A connector within the housing receives a removable multimedia card. Electronic circuitry within the housing includes a data transfer interface (e.g., a universal serial bus (USB) interface). An engagement device (e.g., a USB engagement device) is permanently mounted to the housing. The engagement device is moveable from a home position in which the USB engagement device does not extend from the housing to an operational position in which the USB engagement device extends from the housing. When the engagement device is in the operational position, the engagement device is insertable directly into a mating receptacle (e.g., a USB port) of a computer to provide electrical communication to the data transfer interface without requiring any cables or other interconnection devices. The electronic circuitry within the housing includes a control device coupled to the data transfer interface. The control device receives data and commands from the computer via the engagement device and the data transfer interface and controls the transfer of data between the data transfer interface and the multimedia card. In certain embodiments, the engagement device extends from top of the housing when in the operational position. In other embodiments, the engagement device extends from the back of the housing when in the operational position. Preferably, the engagement device is recessed within the back of the housing when in the home position. Preferably, the control device transfers data between the data transfer interface and the multimedia card in accordance with a USB drive protocol. In certain advantageous embodiments, the cellular telephone includes a power supply coupled to a battery. When the engagement device is inserted into a port of a suitable computer, the power supply couples power from the computer via the engagement device to charge the battery.

In preferred embodiments in accordance with the foregoing aspect of the present invention, the control device and the multimedia card operate together to enable a user to review the files stored in the multimedia card. If the files are data files, the user may only be presented with a representation of the files in the multimedia card in a conventional directory and file format (e.g., file name, file size, file type, creation date, and the like). Rather than having to engage the cellular telephone with a computer, the control device is responsive to commands entered via the keypad to display the file listings on a main display or on a secondary display. Thus, a user having multiple multimedia cards is able to quickly determine whether the correct multimedia card is inserted in the cellular telephone. If the multimedia card includes files having a file structure compatible with the cellular telephone operation (e.g., contact information, configuration files, digital images, or the like), the control device is responsive to user commands to display the information from the files on the main display or on the secondary display. The control device is also responsive to user commands to transfer the contact information or configuration data to the flash memory. Similarly, such information or images can be transferred from the flash memory to the multimedia card via the control device.

Another aspect in accordance with embodiments of the present invention is a method for using a cellular telephone as a solid-state drive for a computer system. The method comprises inserting a multimedia data storage card in a receptacle provided in the cellular telephone. The method further comprises moving a USB engagement device permanently attached to the cellular from a home position to an operational position and then inserting the USB engagement device into a USB port of the computer system. After the engagement device is inserted, the method transfers data between the computer system and the multimedia data storage card. Preferably, the method includes selectively displaying on a display of the cellular telephone a listing of files stored in the multimedia data storage card.

Another aspect in accordance with embodiments of the present invention is a multifunction cellular telephone. The cellular telephone comprises a housing having a keypad, a microphone and a speaker. Electronic circuitry within the housing responds to signals from the keypad to establish a radio frequency communication link to operate the cellular telephone in a cellular communication mode. The housing further includes a multimedia card for storing digital data. A USB interface is coupled to the multimedia card. A USB engagement device is permanently attached to the housing. The USB engagement device is moveable from a home position to an operational position. When the USB engagement device is in the operational position, the USB engagement device is insertable into a USB port of a computer system to enable data transfers between the computer system and the multimedia card via the USB interface to thereby operate the cellular telephone in a solid-state drive mode.

### BRIEF DESCRIPTIONS OF THE DRAWINGS

The foregoing and other features of aspects in accordance with the present invention are described in more detail below in connection with the accompanying drawing figures, in which:

FIG. 1 illustrates a front view of an exemplary flip-style cellular telephone incorporating the present invention, the cellular telephone shown in an open configuration for access to the keypad, main display, and the audio systems;

FIG. 2 illustrates a side view of the cellular telephone of FIG. 1 in the open configuration, and further illustrates the battery pack removed from the rear of the cellular telephone;

FIG. 3 illustrates a rear view of the cellular telephone of FIG. 1 in the open configuration with the battery removed to show the multimedia card (MMC), and further illustrates an embodiment of the USB engagement device in a home position (in phantom lines) and rotated in a plane parallel to the rear of the cellular telephone to an operational position (in solid lines);

FIG. 4 illustrates a side view of the cellular telephone of FIG. 1 in the closed configuration with a portion of the side of the base of the cellular telephone shown in broken lines to show the USB engagement device extended upwardly to the operational position;

FIG. 5 is a perspective view that illustrates the cellular telephone of FIGS. 1-4 with the USB engagement device engaged with a USB port of an exemplary notebook computer;

FIG. 6 illustrates an enlarged detailed view of the area bounded by the dashed circle in FIG. 5, which shows the engagement device inserted into the USB port of the computer;

FIG. 7 illustrates a front view of another embodiment of an exemplary flip-style cellular telephone incorporating another embodiment of the present invention, the cellular telephone shown in an open configuration for access to the keypad, the main display, and the audio systems;

FIG. 8 illustrates a side view of the cellular telephone of FIG. 6 in the open configuration, and further illustrates the battery pack removed from the rear of the cellular telephone;

FIG. 9 illustrates a rear view of an alternative embodiment of the cellular telephone of FIG. 6 in the open configuration with the battery removed to show the multimedia card (MMC), and further illustrates an embodiment of the USB engagement device in the home position (in phantom lines) and pivoted outwardly from the rear of the cellular telephone to an operational position (in solid lines) generally perpendicular to the rear of the cellular telephone;

FIG. 10 illustrates a side view of the cellular telephone of FIG. 6 in the closed configuration with the USB engagement device extended outwardly to the operational position;

FIG. 11 is a plan view that illustrates the cellular telephone of FIGS. 7-10 with the USB engagement device engaged with the USB port of an exemplary notebook computer;

FIG. 12 illustrates a front view of another embodiment of an exemplary flip-style cellular telephone incorporating another embodiment of the present invention, the cellular telephone shown in an open configuration for access to the keypad, the main display, and the audio systems;

FIG. 13 illustrates a side view of the cellular telephone of FIG. 12 in the open configuration, and further illustrates the battery pack removed from the rear of the cellular telephone;

FIG. 14 illustrates a rear view of an alternative embodiment of the cellular telephone of FIG. 12 in the open configuration with the battery removed to show the multimedia card (MMC), and further illustrates an embodiment of the USB engagement device in the home position (in phantom lines) and pivoted outwardly from the rear of the cellular telephone to an operational position (in solid lines) generally perpendicular to the rear of the cellular telephone;

FIG. 15 illustrates a side view of the cellular telephone of FIG. 12 in the closed configuration with the USB engagement device extended outwardly to the operational position;

FIG. 16 is a perspective view of the cellular telephone of FIGS. 12-15 with the USB engagement device engaged with the USB port of an exemplary notebook computer; and

FIG. 17 illustrates a block diagram of the electronic circuitry of a cellular telephone in accordance with aspects of the present invention.

### DETAILED DESCRIPTIONS OF PREFERRED EMBODIMENTS

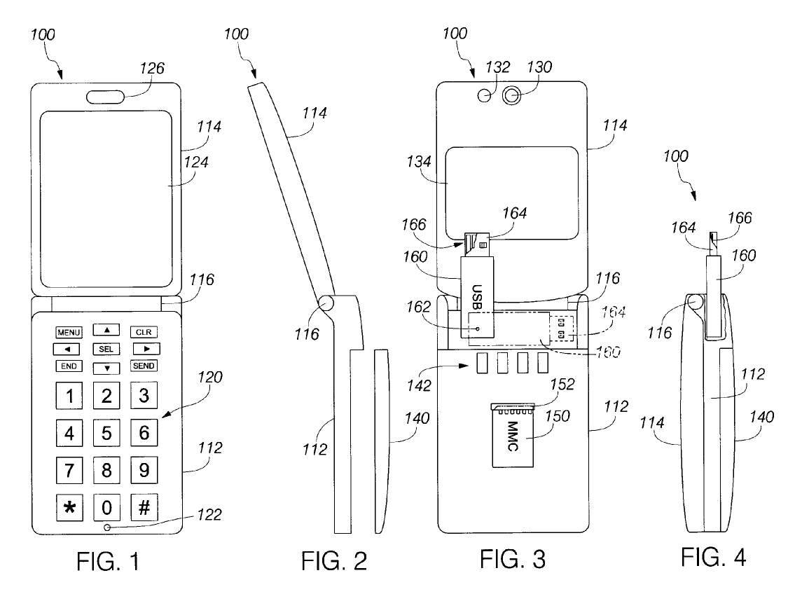

FIGS. 1-4 illustrate an exemplary flip-style cellular telephone 100, which incorporates certain aspects in accordance with the present invention. Although described herein with respect to a two-part flip-style cellular telephone 100, embodiments in accordance with the present invention can also be incorporated into other styles of cellular telephones, and the following description is also applicable to other styles of cellular telephones.

The cellular telephone 100 comprises a base portion 112 and a cover portion 114 that are mechanically coupled by a hinge portion 116. In FIGS. 1-3, the cellular telephone 100 is shown in an open configuration to provide access to a keypad 120 and a microphone 122 positioned on an inside (front) surface of the base portion 112 and to provide access to a main display 124 and a speaker 126 positioned on an inside surface of the cover portion 114. Together, the microphone 122 and the speaker 126 are components of the audio subsystem of the cellular telephone 100. Preferably, the main display 124 is a liquid crystal display (LCD) or other suitable low-power display.

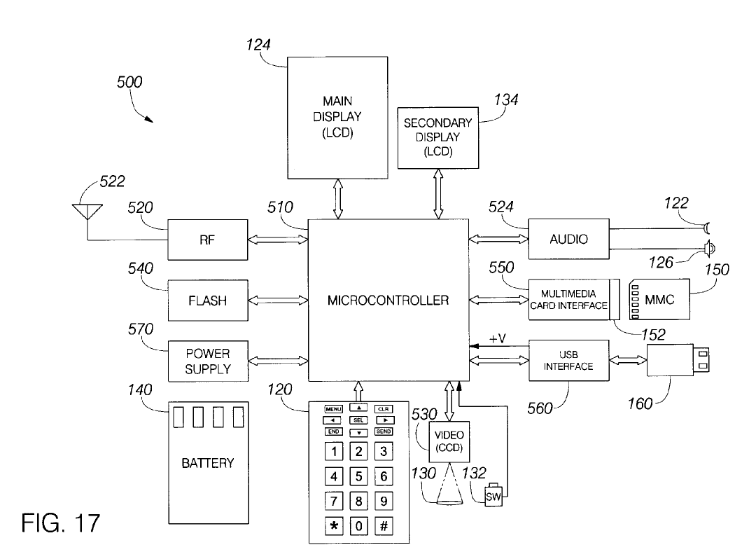

The base portion 112 and the cover portion 114 enclose electronic circuits (see FIG. 17, discussed below) that provide conventional cellular telephone functionality as well as the improved functionality described herein. The electronic circuits in the two portions are interconnected by one or more flexible cables (not shown), which pass through the hinge portion 116 in a conventional manner.

When the cellular telephone 100 is in the open configuration, the inside surfaces of the base portion 112 and the cover portion 114 are exposed to provide access to the keypad 120, the main display 124, the microphone 122 and the speaker 126, which are operable in conventional manners to enable a user to initiate and receive telephone calls and to enable the user to perform various other conventional functions found in many cellular telephones (e.g., text messaging, calendaring appointments and reminders, and the like). In addition, as shown in FIG. 3, the cellular telephone 100 advantageously includes a lens 130 mounted on the outside surface of the cover portion 114. The lens 130 is aligned with an internal light sensing device (not shown), which is advantageously a charge coupled device (CCD). A user is able to operate the cellular telephone 100 as a basic camera by pressing a pushbutton switch 132 mounted on the outside surface of the cover portion 114 proximate to the lens 130.

In certain embodiments, the outside surface of the cover portion 114 further includes a secondary display 134, which is viewable when the cover portion 114 is closed over the base portion 112. The secondary display 134 is preferably an LCD or other suitable low-power display. Generally, the secondary display 134 is smaller than the primary display 124 and displays less information (e.g., time-of-day, incoming caller identification, or the like).

As illustrated in the side view of FIG. 2, the outside (rear) surface of the base portion 112 includes a removable battery pack 140, which provides electrical power to the cellular telephone 100 when the battery pack 140 is charged and is engaged with a set of contacts 142 (FIG. 3) on the base portion 112. The battery pack 140 is advantageously chargeable by placing the cellular telephone 100 in a charging base (not shown) or connecting the cellular telephone 100 to a vehicle power adapter (not shown). One aspect of the present invention discussed below provides an additional way of charging the battery pack 140. In FIG. 2, the battery pack 140 is shown in a disengaged position with respect to the base portion 112.

FIG. 3 illustrates a rear view of the cellular telephone 100 in the open configuration with the battery pack 140 removed. The cellular telephone 100 includes a multimedia card (MMC) 150, which is removably engagable with the electronic circuits in the base portion 112 via a connector 152. In the illustrated embodiment, the MMC 150 comprises non-volatile semiconductor memory (e.g., flash memory). As discussed below, when the cellular telephone 100 is coupled to a computer, the MMC 150 receives and stores data and retrieves and outputs data. Since the memory is non-volatile, the MMC 150 retains stored data even when power is no longer applied to the cellular telephone 100 and when the MMC 150 is removed from the cellular telephone 100. In preferred embodiments, the MMC 150 has a storage capacity in a range from 128 megabytes to 4 gigabytes. A portion of the storage capacity of the MMC 150 may advantageously be used to store telephone numbers, digital images, and configuration information for the conventional functionality of the cellular telephone 100; however, as discussed in more detail below, the greatest portion of the storage capacity of the MMC 150 is used to store data files in the manner of a USB flash drive.

As further shown in FIG. 3, access to the MMC 150 for use as a USB flash drive is provided by a USB port engagement device 160. In the illustrated embodiment, the engagement device 160 is permanently mounted on the rear of the base portion 112 proximate to the hinge portion 116. In the embodiment of FIG. 3, the engagement device 160 pivots (e.g., rotates) about a pivot axis 162 from a home position (shown in phantom lines) to an operational position (shown in solid lines). Both positions of the engagement device 160 are in a common plane, which is generally parallel to the outside (rear) surface of the base portion 112.

In the home position, the engagement device 160 is flush with the rear surface of the base portion 112 or is recessed within the base portion 112. In particular, the engagement device 160 does not extend from the housing of the cellular telephone 100 in the home position. In the home position, the sides of the base portion 112 protect the engagement device 160 from inadvertent contact so that the engagement device 160 does not interfere with the conventional use of the cellular telephone 100. Furthermore, the engagement device 160 is protected from damage that might otherwise occur when the cellular telephone 100 is placed into or removed from a purse or pocket or is handled roughly. The base portion 112 may advantageously include a removable cap (not shown) to cover the engagement device 160 in the recessed home position.

The engagement device 160 is rotatable approximately 90 degrees from the home position to the operational position. In the operational position, the engagement device 160 protrudes from the upper end of the cellular telephone 100 when the cover portion 114 is closed over the base 112. An engagement end 164 of the engagement device 160 comprises an outer shell that protects a plurality of contacts 166 (e.g., 4 contacts for a USB interface). A portion of the outer shell is broken away to show the contacts 166. The outer shell and the contacts are configured as a USB plug to engage a conventional USB port receptacle in a computer.

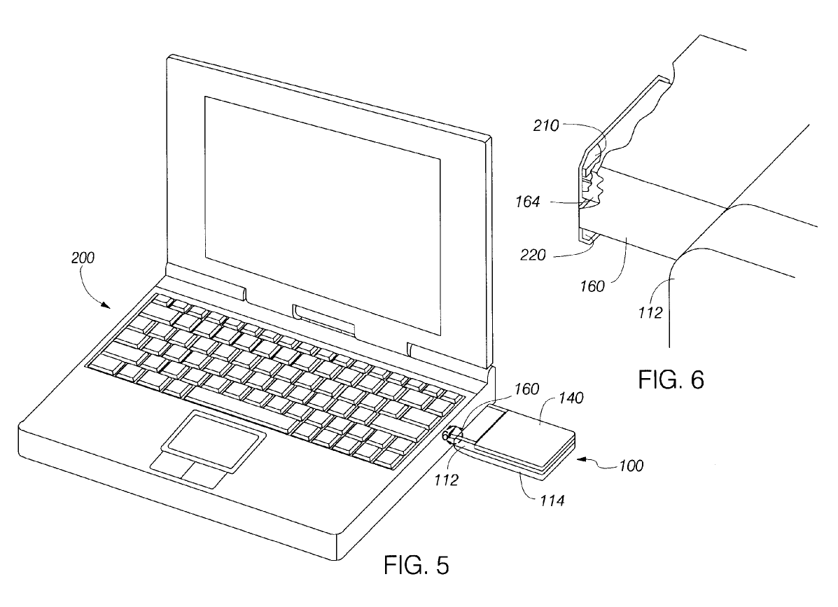

The length of the engagement device 160 is selected to space the base portion 112 and the cover portion 114 a sufficient distance from the computer so that the two portions do not contact the computer when the engagement end 164 is fully engaged with a USB port of a computer other device. For example, FIG. 5 illustrates the cellular telephone 100 plugged into a USB port of an exemplary notebook computer 200. As shown in more detail in the enlarged view of FIG. 6, the notebook computer 200 includes two adjacent USB ports, an upper USB port 210 and a lower USB port 220. The engagement end 164 of the engagement device 160 of the cellular telephone 100 is plugged into the upper USB port 210 in FIGS. 5 and 6.

Because the engagement device 160 is permanently secured to the body of the cellular telephone 100, a user does not have to transport a USB cable or other auxiliary interconnection system in order to connect the cellular telephone 100 to the notebook computer 200 or to another system. When all data transfers are completed, the user only has to unplug the engagement device 160 from the USB port 210 and move the engagement device 160 to the home position. The user does not have to contend with loose interconnection cables or have to find a place to store an independent solid-state drive. The user simply carries the cellular telephone in a conventional manner, and the data files stored in the MMC 150 are readily available when needed.

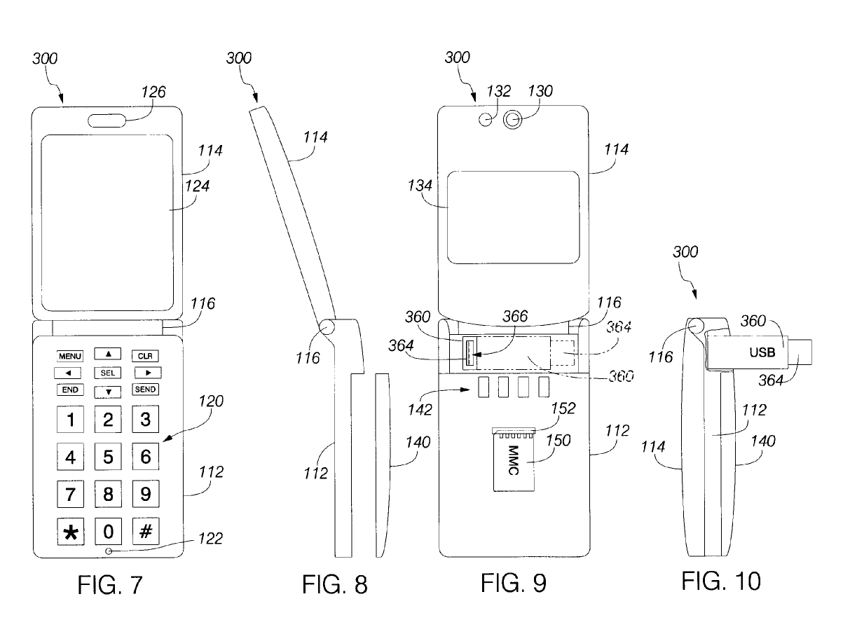

FIGS. 7-10 illustrate another embodiment of an exemplary flip-style cellular telephone 300 that incorporates another embodiment of the present invention. The cellular telephone 300 comprises a USB engagement device 360, which has an engagement end 364 that houses a plurality of contacts 366. The other elements of the embodiment of FIGS. 7-10 are similar to corresponding elements of the embodiment of FIGS. 1-4, and like parts are numbered accordingly in FIGS. 7-10.

As shown in the rear view of the cellular telephone 300 in FIG. 9, the USB engagement device 360 has a home position (in phantom lines) similar to the home position of the USB engagement device 160 of FIG. 3. However, as shown in FIGS. 9 and 10, the engagement device 360 pivots or rotates outwardly from the base portion 112 to an operational position (in solid lines) that is generally perpendicular to a plane defined by the base portion 112. The rotation axis (not shown) of the engagement device 360 is in a plane generally parallel to the rear surface of the base portion. The rotation axis is generally aligned in a direction parallel to the sides of the base portion 112. The embodiment of FIGS. 7-10 is advantageous, for example, when the top of the cellular telephone is obstructed by an antenna (not shown) such that the engagement device 360 cannot be pivoted upwardly in the manner shown in FIGS. 3 and 4.

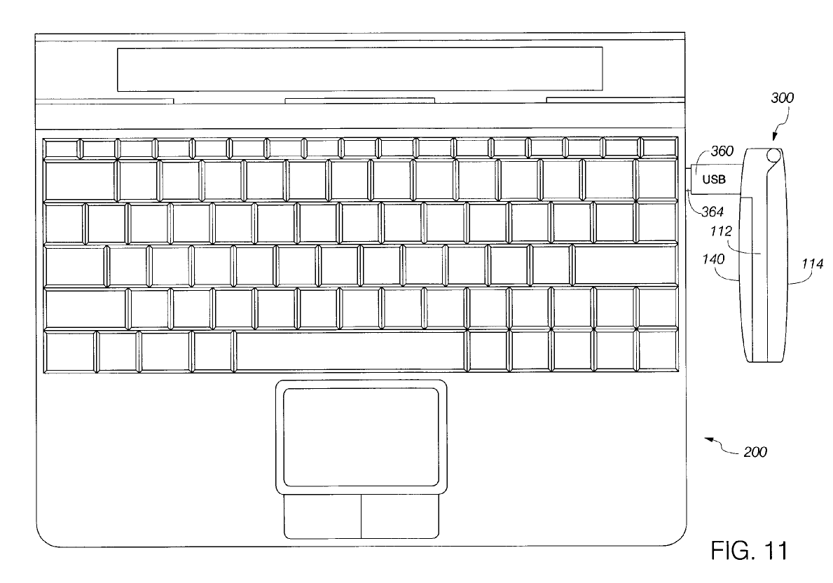

FIG. 11 illustrates the cellular telephone 300 of FIGS. 7-10 with the USB engagement device 360 engaged with the USB port of the exemplary notebook computer 200. As shown in FIG. 11, the cellular telephone 300 of FIGS. 7-10 is generally positioned parallel to the side the notebook computer 200 rather than being positioned perpendicular to the side of the computer as shown for the embodiment of FIG. 5.

The engagement device may also be positioned in other locations and may be rotated differently from a home position to an operational position. For example, in alternative embodiments (not shown), the embodiment of FIGS. 1-4 or the embodiment of FIGS. 7-10 may be modified such that the respective engagement device rotates approximately 180 degrees from the home position and extends from the side of the cellular telephone (e.g., in a direction generally parallel to the hinge portion 116).

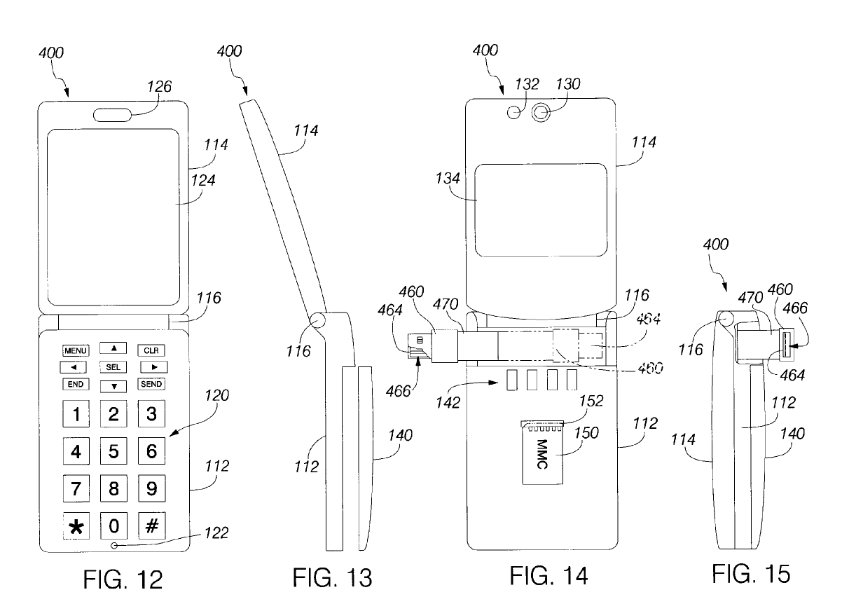

FIGS. 12-15 illustrate another embodiment of an exemplary flip-style cellular telephone 400 that incorporates another embodiment of the present invention in which a portion of the engagement device includes a flexible cable to provide additional freedom in positioning the cellular telephone 400 when engaged with a computer or other systems.

The cellular telephone 400 comprises a USB engagement device 460, which has an engagement end 464 that houses a plurality of contacts 466. The other elements of the embodiment of FIGS. 12-15 are similar to corresponding elements of the embodiments of FIGS. 1-4 and FIGS. 7-10, and like parts are numbered accordingly in FIGS. 12-15.

As shown in the rear view of the cellular telephone 400 in FIG. 14, the USB engagement device 460 has a home position (in phantom lines) similar to the home position of the USB engagement device 160 of FIG. 3. However, as shown in FIGS. 14 and 15, the engagement device 460 is permanently coupled to the cellular telephone 400 via a flexible cable (e.g., a ribbon cable) 470, which allows the engagement device 460 move from the base portion 112 to an operational position (in solid lines) at variable angles and distances from the base portion 112.

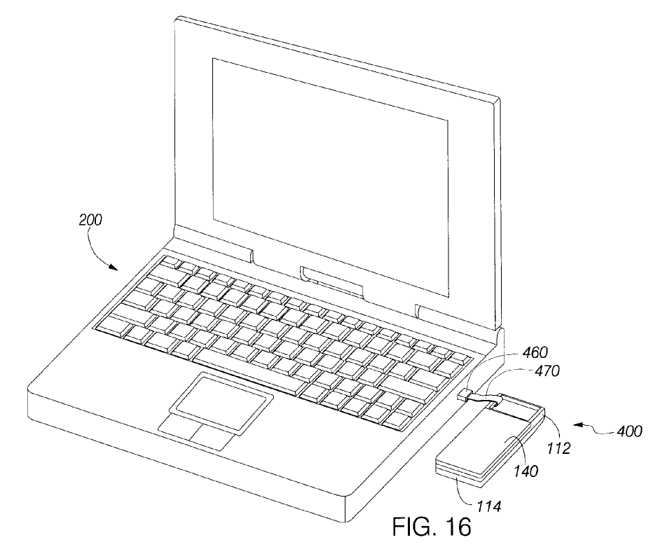

The embodiment of FIGS. 12-15 is advantageous, for example, when the USB port on the notebook computer is located such that the cellular telephone cannot rest on a solid surface when plugged into the computer. For example, FIG. 16 illustrates the cellular telephone 400 of FIGS. 12-15 with the USB engagement device 460 engaged with the USB port of the exemplary notebook computer 200. As shown in FIG. 16, the flexible cable 470 allows the cellular telephone 400 of FIGS. 12-15 to rest on a supporting surface when plugged into the computer 200.

FIG. 17 illustrates a block diagram 500 of the electronic circuitry of the cellular telephone 100 in accordance with aspects of the present invention. The electronic circuits of the cellular telephone 200 and the electronic circuitry of the cellular telephone 300 are similar to the electronic circuitry 500, and are not described separately herein.

The cellular telephone 100 is controlled by a digital control device, which, in the embodiments described herein, is a microcontroller 510. The microcontroller 510 receives control input signals from the keypad 120 and generates control output signals to the main display 124 and the secondary display 134. One skilled in the art will appreciate that in certain embodiments, an application specific integrated circuit (ASIC) may be substituted for the microcontroller 510.

The microcontroller 510 is coupled to an RF subsystem 520. The microcontroller 510 controls the operation of the RF subsystem in response to user commands entered via the keypad 120 or optionally by voice commands. The RF subsystem 520 operates in a conventional manner to receive radio frequency (RF) signals from and to transmit RF signals to an antenna 522. The RF signals include cellular command signals to set up a communication link between the cellular telephone 100 and a cell site (not shown). After the communication link is established, the RF signals are modulated with sounds to provide voice communications to and from the cellular telephone 100 in a conventional manner. The communication link may also transfer other types of data, such as, for example, text messaging data, caller identification information, and the like. In the illustrated embodiments, the antenna 522 is advantageously an internal antenna within the base portion 112. In other embodiments (not shown), the antenna 522 may protrude from the base portion 112 or may be selectively extendable from the base portion 112.

The microcontroller 510 is coupled to an audio subsystem 524. The audio subsystem 524 receives electrical input signals from the microphone 122 responsive to sounds incident on the microphone (e.g., a user's speech). The audio subsystem 524 generates electrical output signals to the speaker 126 to reproduce voice patterns and other sounds. The audio subsystem 524 also advantageously produces ring tones (including short musical passages) and other sounds related to the operation of the cellular telephone 100.

The microcontroller 510 is coupled to a video sensor 530, which is positioned in the cover portion 214 in alignment with the lens 130. The video sensor 530 is advantageously a charge-coupled device (CCD) or other suitable image sensing device, which produces a plurality of electrical signals responsive to light incident on the sensor 530 when the pushbutton switch 132 is depressed by a user.

The microcontroller 510 is coupled to a flash memory 540, which receives and stores digital data representing the configuration of the cellular telephone 100. The configuration data includes, for example, the telephone number associated with the cellular telephone, the owner's name, the selected service, stored ring tones, stored telephone numbers, and the like. The flash memory 540 is non-volatile and retains the configuration information when the cellular telephone is turned off. The flash memory 540 may also advantageously include a limited storage capacity for images produced by the image sensor 530.

The microcontroller 510 is coupled to a multimedia card interface 550. The multimedia card interface is coupled to the removable multimedia card (MMC) 150 via the connector 152. As discussed above, the MMC 150 has a large storage capacity (e.g., up to 4 gigabytes of data).

The microcontroller 510 is coupled to a USB interface 560, which is coupled to the USB engagement device 160. The USB interface 560 is constructed and configured in accordance with Universal Serial Bus Specification, Revision 2.0, Apr. 27, 2000, which is incorporated by reference herein. The microcontroller 510 receives data transfer commands from the computer 200 (FIG. 5) via the USB engagement device 160 and the USB interface 560. The microcontroller 510 is responsive to the commands to transfer data from the USB interface 560 to the MMC 150 and to transfer data from the MMC 150 to the USB interface 560. In preferred embodiments, the microcontroller 510 is programmed to emulate the command and data structure of known solid-state drives. In particularly preferred embodiments, the data transfers conform to the USB 2.0 protocol and data rates, as defined, for example, in the above-cited Universal Serial Bus Specification. When the USB engagement device 160 is plugged into the USB port of a computer system, the computer system senses that a solid-state drive has been plugged in and initiates the appropriate plug-and-play routines to access the disk drive. Accordingly, the MMC 150 within the cellular telephone 100 provides the same features and operational capabilities as a conventional solid-state drive. Thus, the user of the cellular telephone 100 only has to transport and maintain a single device that provides both functions.

In addition to controlling the MMC 150 to operate in a similar manner to a conventional solid-state drive, the microcontroller 510 is advantageously programmable to encrypt the data stored in the MMC 150 so that the data transferred from the MMC 150 cannot be used unless the user enters a correct decryption key, either via the keypad 120 or via the USB interface 160, when the cellular telephone 100 is engaged with a computer or other compatible system.

The microcontroller 510 and the MMC 150 also operate together to enable a user to review the files stored in the MMC 150. If the files are data files, the user may only be presented with a representation of the files in the MMC 150 in a conventional directory and file format (e.g., file name, file size, file type, creation date, and the like). Rather than having to engage the cellular telephone 100 with a computer, the microcontroller 510 is responsive to commands entered via the keypad to display the file listings on the main display 124 or the secondary display 134. Thus, a user having multiple MMCs 150 is able to quickly determine whether the correct MMC 150 is inserted in the cellular telephone 100. If the MMC 150 includes files having a file structure compatible with the cellular telephone operation (e.g., contact information, configuration files, digital images, or the like), the microcontroller 510 is responsive to user commands to display the information from the files on the display 124 or on the display 134. The microcontroller is also responsive to user commands to transfer the contact information or configuration data to the flash memory 540. Similarly, such information or images can be transferred from the flash memory 540 to the MMC 150 via the microcontroller 510.

As further illustrated in FIG. 17, the microcontroller is coupled to a power supply 570, which is coupled to the battery pack 140. The power supply 570 receives DC power from the battery pack 140 and distributes power at the correct voltages to the components described above. The power supply 570 also monitors the quantity of the charge in the battery pack 140 and provides status information to the microcontroller 510. If the cellular telephone 100 is connected to a charging source, the power supply 570 controls the rate at which the battery pack 140 is charged from the charging source.

The USB interface 560 may receive a source of DC power (+V) from the USB port (e.g., the USB port 210) of the computer 200 (FIG. 5) when the USB engagement device 160 is plugged into the USB port. The DC power from the USB port is adequate to trickle charge the battery pack 140, and the microcontroller 510 advantageously configures the power supply 570 to charge the battery pack 140, if additional charge is required. Furthermore, the DC power is adequate to maintain the charge of the battery pack 140 to assure that the battery pack 140 does not discharge below a safe charge level during extended data transfers. The ability to charge the battery pack 140 from the computer 200 may eliminate the need for a separate battery charger in many circumstances.

In alternative embodiments, the cellular telephone may utilize another data transfer bus to interconnect the MMC and a computer. For example, the USB interface may be advantageously replaced with a FireWire (IEEE-1394) interface, and the USB engagement device is configured with the appropriate connector for engaging the corresponding FireWire port on the computer.

One skilled in art will appreciate that the foregoing embodiments are illustrative of the present invention. The present invention can be advantageously incorporated into alternative embodiments while remaining within the spirit and scope of the present invention, as defined by the appended claims.

What is claimed is:

1. A cellular telephone comprising:
a housing;
electronic circuitry within the housing;
a connector for receiving a removable multimedia card and coupling the multimedia card to the electronic circuitry;
a data transfer interface coupled to the electronic circuitry;
an engagement device permanently mounted to the housing, the engagement device having a home position in which the engagement device does not extend from the housing, the engagement device moveable to an operational position in which the engagement device extends from the housing and is insertable directly into a data transfer port of a digital system to provide electrical communication to the data transfer interface; and
a control device coupled to the data transfer interface to receive data and commands via the engagement device, the control device controlling the transfer of data between the engagement device and the multimedia card.

2. The cellular telephone as defined in claim 1, wherein the data transfer interface is a universal serial bus (USB) interface and wherein the engagement device is a USB plug.

3. The cellular telephone as defined in claim 1, wherein the USB engagement device in the operational position extends from top of the housing.

4. The cellular telephone as defined in claim 1, wherein the USB engagement device in the operational position extends from the back of the housing.

5. The cellular telephone as defined in claim 1, wherein the USB engagement device in the operation position extends from the housing via a flexible cable.

6. The cellular telephone as defined in claim 1, wherein the USB engagement device in the home position is recessed within the back of the housing.

7. The cellular telephone as defined in claim 1, wherein the control device transfers data between the data transfer interface and the multimedia card in accordance with a USB solid-state drive protocol.

8. The cellular telephone as defined in claim 1, wherein the cellular telephone includes a power supply coupled to a battery, and wherein the power supply couples power from the engagement device to charge the battery.

9. A method for using a cellular telephone as a solid-state drive for a computer system, comprising:
inserting a multimedia data storage card in a receptacle within the housing of the cellular telephone;
moving a USB engagement device permanently attached to the housing of the cellular telephone from a home position to an operational position;
inserting the USB engagement device into a USB port of the computer system; and
transferring data between the computer system and the multimedia data storage card.

10. The method as defined in claim 9 further comprising selectively displaying on a display of the cellular telephone a listing of files stored in the multimedia data storage card.

11. A multifunction cellular telephone comprising:
a housing;
a keypad;
a microphone;
a speaker;
electronic circuitry within the housing responsive to signals from the keypad to establish a radio frequency communication link to operate the cellular telephone in a cellular communication mode;
a removable multimedia card within the housing for storing digital data;
a USB interface within the housing coupled to the multimedia card; and
a USB engagement device permanently attached to the housing, the USB engagement device moveable from a home position to an operational position, the USB engagement device in the operational position being insertable into a USB port of a computer system to enable data transfers between the computer system and the multimedia card to operate the cellular telephone in a solid-state drive mode.
